(19) United States
(12) Patent Application Publication
(10) Pub. No.: US 2018/0349125 A1
(43) Pub. Date: Dec. 6, 2018

(54) INFORMATION PROCESSING APPARATUS AND PROGRAM MANAGEMENT METHOD

(71) Applicant: CANON KABUSHIKI KAISHA, Tokyo (JP)

(72) Inventor: Mario Ito, Kawasaki-shi (JP)

(21) Appl. No.: 15/988,409

(22) Filed: May 24, 2018

(30) Foreign Application Priority Data
Jun. 1, 2017 (JP) 2017-109317

(51) Int. Cl. G06F 8/65; H04N 1/00; G06F 3/12; G06F 8/61

(52) U.S. Cl. CPC G06F 8/65; H04N 1/00344; G06F 3/123; G06F 3/1225; G06F 8/62; H04N 2201/0039; H04N 1/00233; H04N 1/0022; H04N 1/00278; H04N 1/00925; H04N 1/00244

(57) ABSTRACT

When installing an update program of an application, the update program and information regarding the update program are stored in an area that is different from the area where an existing application is stored. At the time of activation of the application, the information regarding the update program is referenced, and control is performed to activate the application. Also, the information regarding the update program is written or removed in response to an instruction to start or stop the update program. A program that corresponds to the latest information is executed at the time of program execution.

### BACKGROUND OF THE INVENTION

### Field of the Invention

The present invention relates to an information processing apparatus and a program management method, with which an application can be updated/added.

### Description of the Related Art

A configuration is known in which an information processing apparatus such as a PC is connected to a web server deployed on a network, and an operation screen provided by a web application installed on the web server is displayed on a web browser installed on the information processing apparatus.

In this case, the web browser of the information processing apparatus first sends a request for an operation screen to the web application installed on the web server. Then, in response to the request from the information processing apparatus, the web application sends a response containing HTML data for displaying an operation screen on the web browser to the information processing apparatus. The web browser of the information processing apparatus analyzes the received HTML data, and displays an operation screen based on a script included in the HTML data.

Furthermore, if a user inputs an instruction via the operation screen displayed on the web browser, the web browser notifies the web server of the input instruction. Then, upon receiving the notification, the web application on the web server executes processing in accordance with the input instruction.

In recent years, some image processing apparatuses called MFPs (Multi Function Peripherals) that are equipped with a scanner and a printer include a web browser as described above.

New specifications and new techniques are constantly developed for web technologies such as HTML 5, ECMAScript 6 and CSS 3, making advancement day by day. Web browsers are frequently updated to conform to their new specifications, and along with changes in the specifications of the web browsers and addition of new specifications, web applications are also updated very often. On the other hand, there are web applications, such as business use applications, that cannot be updated frequently for some reasons. In order to use such web applications, it is often the case that web browsers are left unupdated.

However, in order to view websites in which advancement is made day by day, it is necessary to use a new web browser that supports such websites. For this reason, there is a desire to use a most recent web browser so as to view most recent websites while maintaining an older web browser so as to use web applications that cannot be updated frequently. However, when an update program for the most recent web browser is installed, the program of the older web browser is eliminated. Japanese Patent Laid-Open No. 2016-103159 discloses an example in which a backup of a program (web browser) is made when an update program for the program (web browser) is installed so as to enhance the reliability of the update, but the backup is removed upon completion of the update. In order to again use the older web browser, it is necessary to again install the older web browser. Accordingly, this technique is problematic in that it is not possible to have both older and most recent web browsers on the same information processing apparatus, and also switching is not easily performed between older and most recent web browsers.

### SUMMARY OF THE INVENTION

The present invention provides an information processing apparatus and a program management method, with which it is possible to properly use different versions of a program with a simple operation, and improve usability.

The present invention has the following configuration. Specifically, according to one aspect of the present invention, there is provided an information processing apparatus comprising: at least one processor; and at least one memory in which a computer program executed by the processor is stored, wherein the processor executes the computer program so as to cause the information processing apparatus to function as: an update unit that installs an update version program for an existing program as a program that is different from the existing program, and stores registration information that indicates that the update version program has been registered; an execution control unit that performs control so as to determine which of the existing program and the update version program is to be executed based on the registration information at a time of program execution; and a removing unit that, in response to an operation for stopping execution of the update version program, stops the update version program, and removes the registration information of the update version program.

According to the present invention, it is possible to properly use different versions of a program with a simple operation, and improve usability.

Further features of the present invention will become apparent from the following description of exemplary embodiments (with reference to the attached drawings).

### BRIEF DESCRIPTION OF THE DRAWINGS

FIG. 1 is a diagram showing an overall configuration of a system in which an MFP according to an embodiment of the present invention is connected.

FIG. 2 is a block diagram showing a hardware configuration of the MFP according to the embodiment of the present invention.

FIGS. 3A and 3B are diagrams showing a software configuration of update information and an additional application storing portion according to the embodiment of the present invention.

FIGS. 4A and 4B are diagrams respectively showing an update information table in an initial state and the update information table after an update has been made according to the embodiment of the present invention.

FIG. 5 is a diagram showing a sequence for installing an update program according to the embodiment of the present invention.

FIG. 6 is a diagram showing a flow of activating a program performed by a program activating portion according to the embodiment of the present invention.

FIG. 7 is a diagram showing an additional application management screen according to the embodiment of the present invention.

FIG. 8 is a diagram showing a correspondence table between JavaScript and web browser version according to the embodiment of the present invention.

FIG. 9 is a diagram showing a sequence for automatically switching a web browser according to the embodiment of the present invention.

FIG. 10 shows an example of a JavaScript file that is used to make a determination in the sequence for automatically switching a web browser according to the embodiment of the present invention.

FIGS. 11A and 11B are diagrams respectively showing a processing flow performed in response to a stop instruction and a processing flow performed in response to a start instruction according to Embodiment 1.

### DESCRIPTION OF THE EMBODIMENTS

Hereinafter, embodiments according to the present invention will be described with reference to the drawings.

### Embodiment 1

### System Configuration

FIG. 1 is a diagram showing an example of a configuration of a system that uses an image processing apparatus according to the present embodiment. The system includes an MFP 101 that is an image processing apparatus that is connected via a network 100, and a web server 102 that is an external apparatus of the MFP 101. The MFP 101 may also be referred to as “information processing apparatus” if attention is paid to its information processing function. The network 100 is an infrastructure for apparatuses to perform communication therebetween, and may be connected to the Internet. The MFP 101 may be any apparatus as long as it has a web browser function, and thus is not limited to a MFP (Multiple Function Peripheral). The web server 102 is connected to the MFP 101 via the network 100, has a function of distributing web content via the network 100, and provides web content in response to a request from the MFP 101. The apparatuses may be present on a local network, or may be connected over the Internet. Also, the web server 102 may be incorporated in the MFP 101 as a function of the MFP 101.

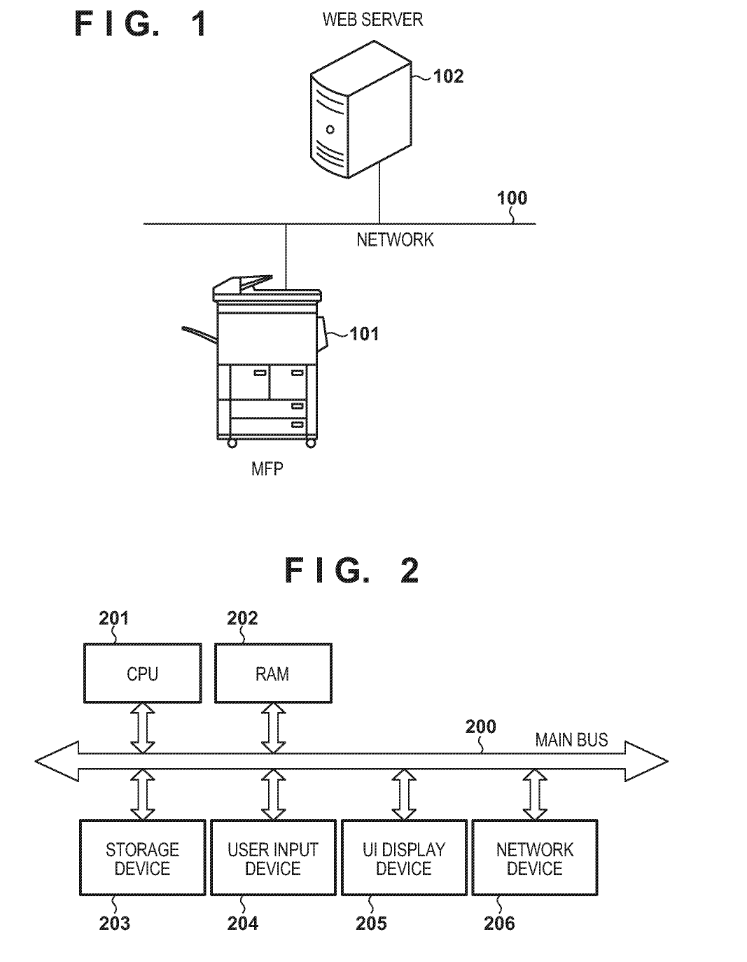

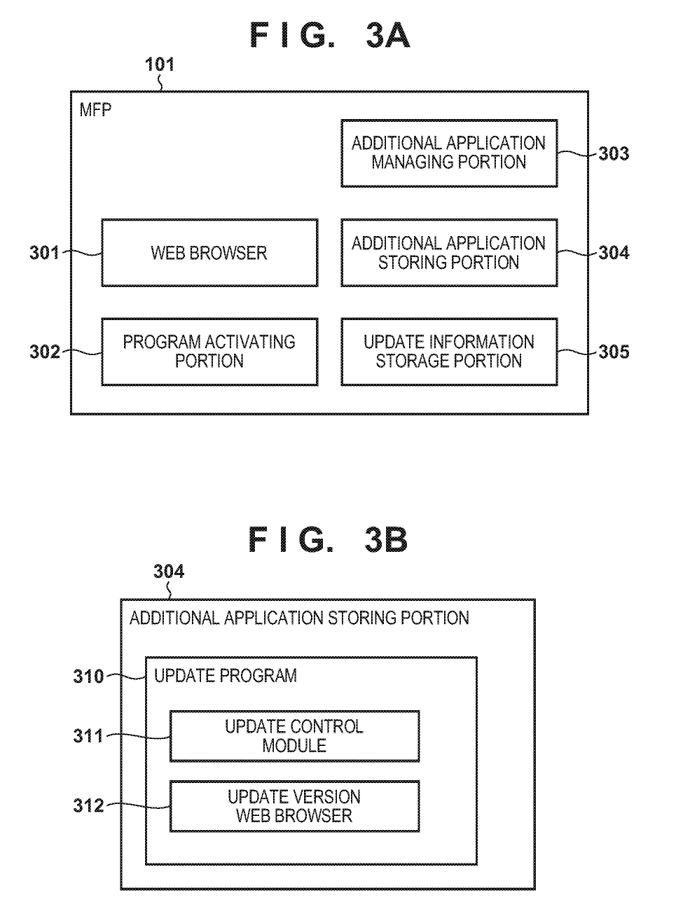

FIG. 2 is an example of a hardware configuration of the MFP 101 and the web server 102 according to the present embodiment. In this configuration example, a CPU 201 that controls the entire apparatus, a RAM 202 that provides a work area for the CPU 201, and a storage device 203 (a HDD, a NVRAM, or the like) that stores a program for implementing the invention according to the present embodiment and various settings are included. Furthermore, a user input device 204 that is used by a user to input a command, a UI display device 205 that provides a display on a screen, a network device 206 that performs network communication with other devices, and a main bus 200 are included. In the present embodiment, unless otherwise stated, in the MFP 101 and the web server 102, the CPU 201 controls the RAM 202, the storage device 203, the user input device 204, the UI display device 205, and the network device 206 via the main bus 200. The UI display device 205 may also function as the user input device 204, like a touch panel display. Note that the web server 102 does not necessarily include the user input device 204 and the UI display device 205. Also, in the MFP 101, an image reading device or an image printing device may be connected to the main bus 200.

### Software Configuration

FIG. 3A is a diagram illustrating a software configuration of the MFP 101 according to the present embodiment. The functional portions shown in FIG. 3A are implemented by the CPU 201 of the MFP 101 executing a control program. The MFP 101 includes a web browser 301, a program activating portion 302, an additional application managing portion 303, an additional application storing portion 304, and an update information storage portion 305. With these functional portions, a program management method of the MFP 101 is implemented.

The web browser 301 may be any web browser as long as it has a function of acquiring web content by performing communication with an arbitrary server and displaying the acquired web content on a screen.

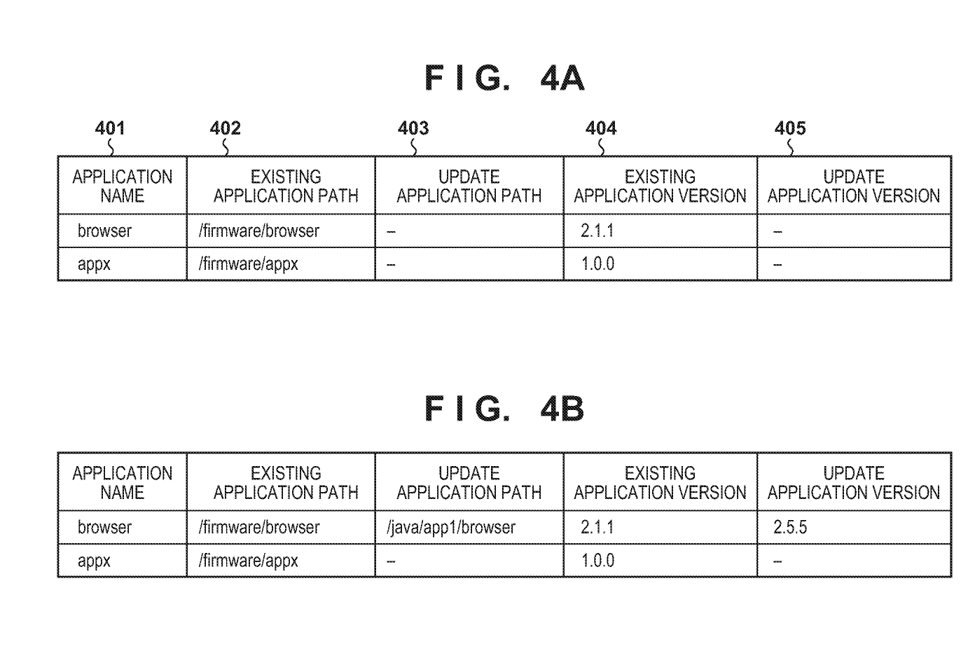

The program activating portion 302 is a program that is activated at the same time when the MFP 101 is activated, and functions to activate the web browser 301. In the present embodiment, an example is shown in which the program activating portion 302 activates the web browser, but may function to activate other general-purpose programs. The program activating portion 302 references to an update information table (FIG. 4A), which is stored in the update information storage portion 305, at the time of activation of the MFP 101 or when a request to activate the web browser 301 is received from other programs. The update information table (FIG. 4A) is a table that includes, for each application, information such as application name 401, existing application path 402, update application path 403, existing application version 404, and update application version 405. The application name is the identification information of an application, the application path is information for identifying (or specifying) the location of the application, and the application version is information for identifying (or specifying) the edition (version) of the application. The program activating portion 302 searches for a row that has “browser”, which indicates a web browser, in the application name 401, and determines whether a value is stored in the update application path 403 by referencing to the update application path 403 of that row. If it is determined that a value is stored in the update application path 403 (see FIG. 4B), it means that an update version application is present in the location indicated by the value stored in the update application path 403. At this time, the program activating portion 302 compares the existing application version 404 with the update application version 405, and if it is determined that the update application version 405 is more up-to-date than the existing application version 404, the program activating portion 302 activates the web browser present in the location indicated by the value stored in the update application path 403. If, on the other hand, it is determined that the update application version 405 is older than the existing application version 404, the program activating portion 302 activates the web browser present in the location indicated by the value stored in the existing application path 402, rather than in the update application path 403. This is because the update version application may be older than the existing application. On the other hand, if it is determined that a value is not stored in the update application path 403 (FIG. 4A), it means that an update program is not installed, and thus the program activating portion 302 activates the web browser present in the location indicated by the value stored in the existing application path 402.

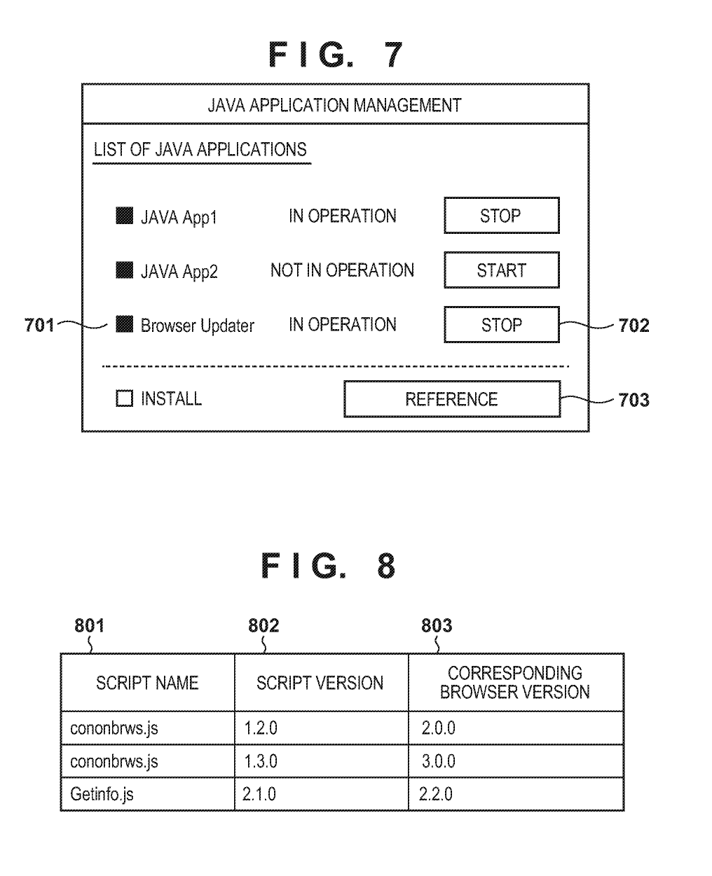

The additional application managing portion 303 is a program that performs control so as to install/uninstall an additional application with respect to the MFP 101 or start/stop the additional application. As used herein, “additional application” refers to an application that is not installed by default on the firmware of the MFP 101, and a program that can be added later. For example, in the case where the MFP 101 includes a platform for executing applications written in Java®, additional applications are made as Java® applications, and the additional application managing portion 303 may serve as a management module for managing Java VM applications and Java applications. The additional application managing portion 303 is capable of displaying an application management screen (FIG. 7) on the UI display device 205, and thus the user can perform control so as to install/uninstall an additional application, or start/stop the additional application via the application management screen (FIG. 7). In the present embodiment, it is assumed that the MFP 101 also includes a web server, and the application management screen (FIG. 7) is implemented on the MFP 101 as a web application. The administrator or user can use the additional application managing portion 303 by accessing the web server provided in the MFP 101 from a web browser installed on a PC (not shown) connected to the network 100, or the web browser 301 installed on the MFP 101.

The application management screen (FIG. 7) includes an application state 701 and an application control button 702 for each installed additional application, and also includes a reference button 703 used to look for an additional application to be installed. The application state 701 indicates whether or not the installed additional application is running. The application control button 702 is a button for switching the additional application between start and stop. The reference button 703 is a button used to install the additional application, and by pressing the reference button 703, it is possible to select an additional application stored in the PC (not shown) and install the additional application. If the additional application managing portion 303 receives an instruction to install an additional application via the reference button 703 on the application management screen (FIG. 7), the additional application managing portion 303 stores the additional application indicated by the instruction in the additional application storing portion 304. Also, the additional application managing portion 303 starts the additional application at the same time when the additional application is installed.

The additional application storing portion 304 is an area where an additional application is stored when the additional application is installed via the additional application managing portion 303, and thus is different from the area where the web browser 301 is stored. Accordingly, if an update program 310 for updating the web browser is installed as an additional application, the update program 310 is stored in the additional application storing portion 304, and the existing web browser 301 is not overwritten. If, on the other hand, a plurality of additional applications that have or use a web browser function are installed, the additional applications of older versions may be overwritten by the additional applications of newer versions, or they may be stored in parallel, and exclusively operated.

FIG. 3B shows a configuration of the additional application storing portion 304 in which the update program for the web browser is installed as an additional application. The update program 310 is stored in the additional application storing portion 304. The update program 310 includes an update control module 311 for updating a program to be updated, and an update version program (in this example, an update version web browser 312) that is a newer version of the program to be updated. The update control module 311 is executed upon start of the update program 310 via the additional application managing portion 303. The update control module 311 stores, in the update information table stored in the update information storage portion 305, the path to the location where the update version web browser 312 is provided, and the version information of the update version web browser 312. The path to the location where the update version web browser 312 is provided is stored in the update application path 403, and the version information of the update version web browser 312 is stored in the update application version 405. The same applies to the case where an additional application is started via the application control button 702 (“start” button) on the application management screen (FIG. 7). That is, if the update program 310 that is not running is selected as a target program, and the “start” button is pressed, the update control module 311 of the update program 310 is executed, and as described above, the path to the location where the update version web browser 312 is provided is stored in the update application path 403, and the version information of the update version web browser 312 is stored in the update application version 405.

On the other hand, if the additional application is stopped via the application control button 702 (“stop” button) on the application management screen (FIG. 7), the update control module 311 removes the information of the stopped additional application stored in the update application path 403 and the update application version 405 from the update information table stored in the update information storage portion 305. FIG. 4A shows the update information table indicating a state in which none of the update version web browser 312 and the additional application is installed or running. On the other hand, FIG. 4B shows the update information table indicating a state in which the update version web browser 312 with a version 2.5.5 is installed and running.

In the case where a plurality of update programs 310 of different versions have been installed for the same program such, as for example, web browser, it is also possible to select an update program of a version to be executed through the above-described procedure. That is, because update programs of different versions are installed separately for each version, it is only necessary for the user to select an update program of a version the user wants to use, and then press the “start” button on the application management screen. However, in this case, in order to exclusively execute the update program of the selected version, the update programs other than the version for which the “start” button was pressed are stopped, and after that, the update program of the selected version is executed. By doing so, the update application path and the version of the update applications of the other versions that were not selected to be executed are removed from the update information table, and after that, the update application path and the version of the update application of the version to be executed are registered. Then, the execution of the update version program, for example, web browser, of the registered version is started.

In the case of an application that is not an update version (that is, an application installed for the first time), the application name 401, the existing application path 402, and the existing application version 404 of the application are registered in the update information table when the application is installed.

The update information storage portion 305 is a storage area where the update information table (FIG. 4A or 4B) is stored. As described above, the update information table is rewritten by the update control module 311 of the update program 310 stored in the additional application storing portion 304.

Sequence for Installing Update Program

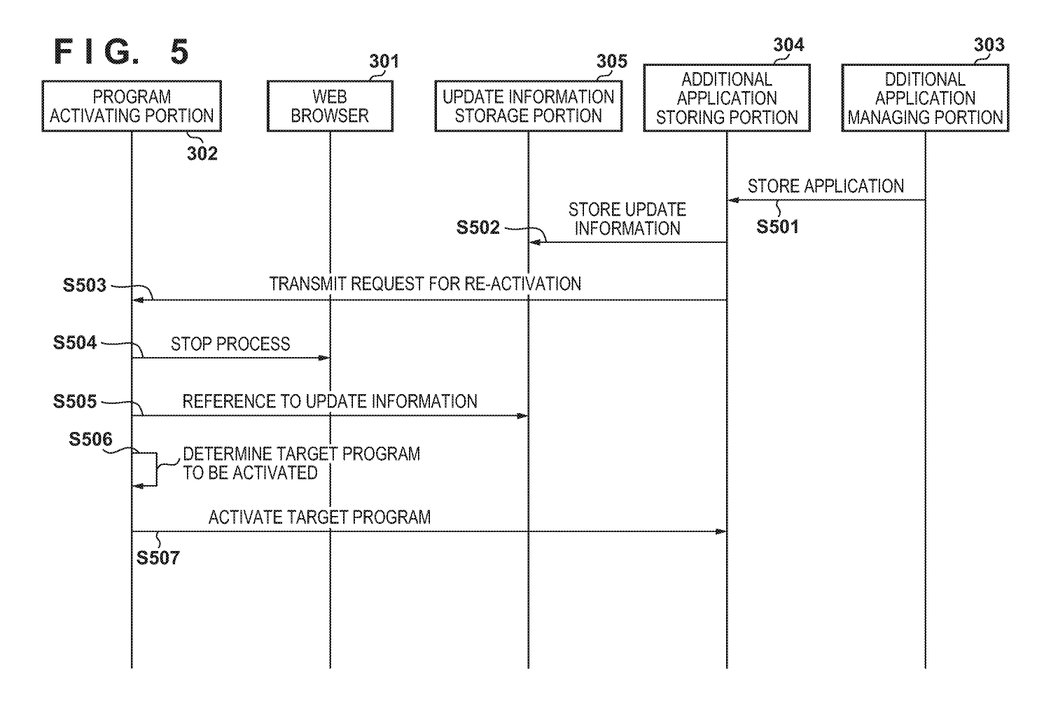

FIG. 5 shows a sequence for installing an update program according to the present embodiment, which is the processing performed when an instruction to install the update program 310 is provided to the additional application managing portion 303 via the application management screen (FIG. 7).

In step S501, the additional application managing portion 303 stores the update program 310 in the additional application storing portion 304, and starts the update program 310.

In step S502, the update control module 311 of the update program 310 stored in the additional application storing portion 304 stores the path to the update program 310 and the version of the update program 310 in the update information table stored in the update information storage portion 305. At this time, the update program 310 searches, based on the application name of the application to be updated (in this example, application name “browser”), the update information table (FIG. 4A or 4B) for a row that has an application name that matches the application name, so as to determine the row as a record that indicates a target application. If such a record is found, the update program 310 records the path to the update version program and the version of the update version program in the update application path 403 and the update application version 405 of the record. If such a record is not found, the update program 310 may record, for example, the path to the update version program and the version of the update version program in the existing application path 402 and the existing application version 404 of the record. By doing so, an update version program installed in a state in which there is no existing program recorded in the update information table is recorded as an existing (or in other words, installed) program in the update information table. Alternatively, if such a record is not found, the fact may be notified to the user by providing a display informing the fact on the UI display device 205.

In step S503, the update control module 311 of the update program 310 stored in the additional application storing portion 304 transmits a request for reactivation of the web browser to the program activating portion 302.

In step S504, the program activating portion 302 stops the web browser 301.

In step S505, the program activating portion 302 references to the update information table (FIG. 4A or 4B) of the web browser stored in the update information storage portion 305.

In step S506, the program activating portion 302 determines, based on the update information table referenced in step S505, which of the existing program and the update program is to be activated. Here, the latest version of the application registered in the update information table is determined as the application to be executed. In this example, there is an update application path 403 to the web browser, and the update application version 405 is more up-to-date than the existing application version, and thus the program activating portion 302 determines that the program specified by the value written in the update application path 403 is to be activated.

In step S507, the program activating portion 302 activates the application determined in step S506, in this example, the update version web browser 312 of the update program 310 stored in the additional application storing portion 304.

As described above, an update program is activated when the update program is installed. Also, the flow of activating an update program at the time of activation of the MFP 101 is the same as the processing starting from step S505 to step S508.

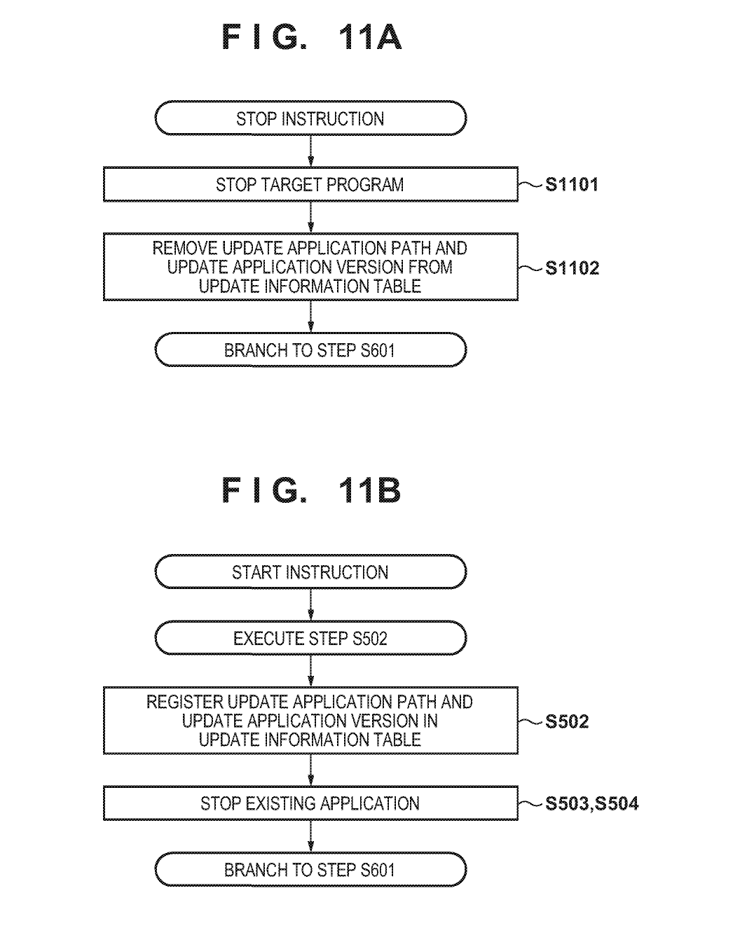

The procedure performed in response to the “start” button or the “stop” button being pressed on the application management screen (FIG. 7) will be described later with reference to FIGS. 11A and 11B.

Determination of Application to be Activated

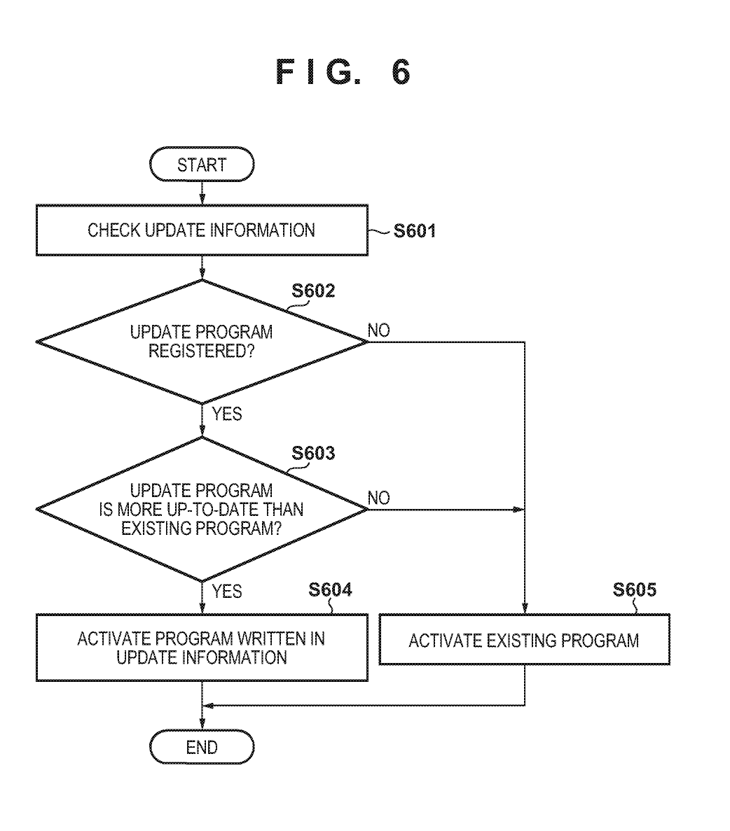

FIG. 6 is a flow of processing for determining which of the existing application and the update version application is to be activated, or in other words, processing for determining (or executing) the version to be activated, which is performed by the program activating portion 302. This procedure is executed on software by the program activating portion 302, and on hardware by the CPU 201. This procedure corresponds to the processing starting from step S505 to step S507 shown in FIG. 5, and is executed by the program activating portion 302.

In step S601, the program activating portion 302 references to the update information of the target program stored in the update information storage portion 305.

In step S602, the program activating portion 302 checks whether the update application path 403 is written in the update information referenced in step S601. If it is determined that the update application path is written, the procedure advances to step S603. If it is determined that the update application path is not written, the procedure advances to step S605.

In step S603, the program activating portion 302 checks whether the version of the update application is more up-to-date than the version of the existing application in the update information referenced in step S601. If it is determined that the version of the update application is more up-to-date than the version of the existing application, the procedure advances to step S604. Otherwise, the procedure advances to step S605.

In step S604, the program activating portion 302 activates the program indicated by the value written in the update application path 403 included in the update information referenced in step S601.

In step S605, the program activating portion 302 activates the program indicated by the value written in the existing application path 402 included in the update information referenced in step S601.

Procedure for Starting and Stopping Application

FIGS. 11A and 11B respectively show processing procedures performed by the MFP 101 in the case where a “stop” button (hereinafter also referred to as “stop instruction”) has been pressed and in the case where a “start” button (hereinafter also referred to as “start instruction”) on the application management screen shown in FIG. 7. In response to a stop instruction on the application management screen displayed by the web browser, the web server provided in the MFP 101 receives the stop instruction. The stop instruction is transferred to, for example, the additional application managing portion 303, and the target program for which the stop instruction has been issued is stopped (S1101). At this time, if the target program is the update program 310, the update version program (for example, the update version web browser 312) included in the update program 310 is also stopped. Then, the update application path 402 and the update application version 405 of a row that has the name of the target program as the application name are removed from the update information table (S1102). After that, the procedure branches to step S601 shown in FIG. 6, and the existing program before an update is executed. As a result, the update version program is stopped, and the existing program that remains unupdated is executed.

On the other hand, in the case where a start instruction is input on the application management screen, the web server provided in the MFP 101 receives the start instruction. In response to the start instruction, for example, the additional application managing portion 303 executes the target program for which the start instruction has been issued. Accordingly, step S502 shown in FIG. 5 is executed. After step S502, the target program for which the start instruction has been issued is executed if it is a normal additional application. If, on the other hand, the target program is the update program 310, the update program 310 is executed, and the location and the version of the update program 310 are registered in the update application path 403 and the update application version 405 of the update information table (S502), and the existing application is stopped by the program activating portion 302 (S503, S504). After that, the program activating portion 302 executes the procedure from step S601 shown in FIG. 6.

Through the above-described processing, the path to the update program 310 and the version of the update program 310 are registered in the update application path 403 and the update application version 405 of the update information table, the procedure shown in FIG. 6 is executed, and the update version program (update version web browser) is executed.

With the configuration and procedure described above, it is possible to provide an instruction to stop or start an update application on the screen displayed by the web browser, and easily perform switching between the existing program and the update program.

If the update program is configured to install a version that is more up-to-date than the version of the existing program, the program to be activated may be determined based on whether the update program has been registered, rather than based on the version information.

To be specific, in FIGS. 4A and 4B, the update application path 403 that corresponds to registration information is stored without storing the existing application version 404 and the update application version 405 that correspond to version information. This eliminates the determination process performed in S603 shown in FIG. 6.

### Embodiment 2

The method described above is configured such that the user makes a setting on the application management screen (FIG. 7) as to whether to use the update program or the existing program. For this reason, it is necessary for the user to perform a switching operation on, for example, the application management screen shown in FIG. 7 time to time as appropriate. In the present embodiment, the application automatically determines a corresponding web browser and performs switching based on the difference in a script, for example, a JavaScript® library contained in the web content. In the present embodiment as well, as in Embodiment 1, a newly installed update program is registered in the update information table (FIG. 4A or 4B), and the update application path to the update program and the update application version of the update program are removed or registered in response to a stop or start instruction, whereby the version of the web browser that is executed can be specified.

Determination of Version to be Executed by Using Script

FIG. 8 shows a version correspondence table or correspondence information in which the JavaScript® and the web browser version are associated and that is used to determine which of the existing application and the update version application is to be activated according to the content. The version correspondence table is stored in the update information storage portion 305, and is updated by the update control module 311 when the update program 310 is installed. The version correspondence table includes script name 801, script version 802, and corresponding browser version 803. The corresponding browser version 803 shows a browser that corresponds to a script specified by the script name 801 and the script version 802. When the web browser 301 or the update version web browser 312 downloads a JavaScript® contained in the web content of the server 102, the script name and the script version of the downloaded script are acquired. The program activating portion 302 references to the corresponding browser version 803 based on the script name 801 and the script version 802. Then, the program activating portion 302 compares the referenced browser version 803 with the version of the web browser that is currently running, and if it is determined that the browser version 803 is different from the version of the currently running web browser, the program activating portion 302 stops the currently running web browser, and activates the web browser of the browser version 803. The currently running web browser can be specified by, for example, referencing to the update information table (FIG. 4A or 4B) according to Embodiment 1, or the like. Also, at the time of activation of the web browser, the program activating portion 302 references to the update information table (FIG. 4A or 4B), and determines whether there is an existing application 404 or an update application version 405 that matches the browser version 803. If a version that matches the browser version 803 is found, the location of the matching version is specified using an application path that corresponds to the matching application, and the application (web browser) is activated. If such a version is not found, for example, the latest version may be activated.

FIG. 10 shows an example of a JavaScript® contained in the web content. The JavaScript® library contained in the web content includes JavaScript® library name 1001, and JavaScript® library version 1002. As a result of the web browser 301 or the update version web browser 312 referencing to these, the program activating portion 302 can determine the version of the corresponding web browser based on the version correspondence table.

Switching of Web Browser

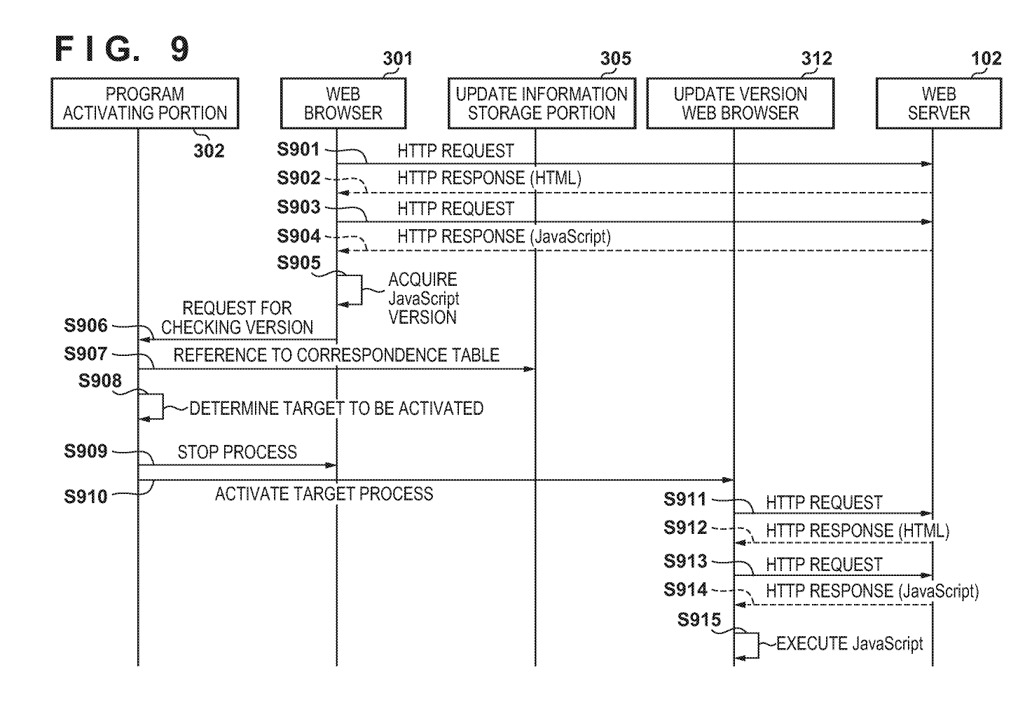

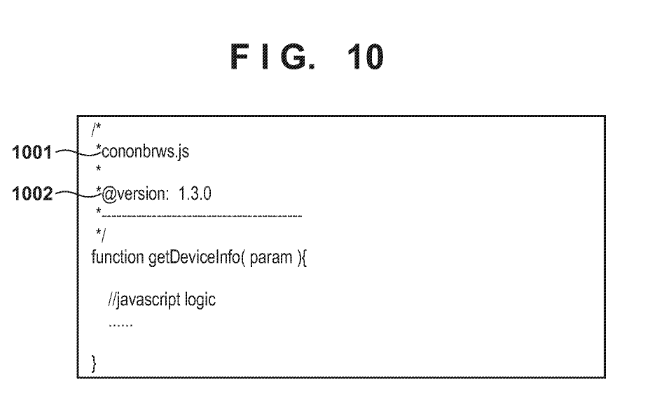

FIG. 9 shows a sequence for switching the web browser to be used according to the version of the JavaScript library, which is performed by the program activating portion 302.

In step S901, in order to acquire screen information of the web application, the web browser 301 transmits a HTTP request to the web server 102.

In step S902, the web server 102 transmits HTML data as a response to the request received in step S901.

In step S903, the web browser 301 analyzes/executes the HTML data received in step S902, and transmits a HTTP request for acquiring the JavaScript® library.

In step S904, the web server 102 transmits the JavaScript® library as a response to the request received in step S903.

In step S905, the web browser 301 acquires the library name and the library version from the JavaScript® library received in step S904.

In step S906, the web browser 301 notifies the program activating portion 302 of the library name and the library version acquired in step S905, as well as the URL to which the request was transmitted in step S901.

In step S907, the program activating portion 302 acquires the corresponding browser version from the version correspondence table stored in the update information storage portion 305 based on the library name and the library version notified in step S906. This example will be described based on the assumption that a version that corresponds to the update version web browser 312 is acquired. As used herein, the term “correspond” refers to a state in which, for example, the interfaces of programs (for example, the script and the web browser) match and operate properly.

In step S908, the program activating portion 302 determines which web browser is to be activated based on the corresponding browser version acquired in step S907. To be specific, because the currently activated web browser is the web browser 301 whose version has not been updated, the program activating portion 302 determines that the web browser 301 is to be stopped and the update version web browser 312 is to be activated. At this time, if there is no web browser whose version corresponds to the script, a dialog for notifying that fact may be displayed.

In step S909, the program activating portion 302 stops the web browser 301.

In step S910, the program activating portion 302 activates the web browser whose version corresponds to the script, in this example, the update version web browser 312 stored in the additional application storing portion 304. At this time, the program activating portion 302 notifies the update version web browser 312 of the URL received in step S906.

In step S911, the update version web browser 312 transmits a request to the web server 102 in accordance with the URL received in step S910.

In step S912, the web server 102 transmits HTML data to the update version web browser 312.

In step S913, the update version web browser 312 analyzes/executes the HTML data received in step S912, and transmits a HTTP request for acquiring the JavaScript® library.

In step S914, the web server 102 transmits the JavaScript® library as a response to the request received in step S913.

In step S915, the update version web browser 312 executes the JavaScript® library received in step S914.

In this example, the version of the corresponding web browser is specified based on the name and version of the JavaScript®, but the method is not limited thereto. For example, it may be specified by a hash value of a JavaScript® file, or may be determined based on the type or version of JavaScript® API contained in a JavaScript® file. In this way, in the present embodiment, the web browser that corresponds to the downloaded script can be executed without requiring the user to perform a switching operation. This further improves ease of operation.

With the configuration described above, a plurality of different versions of a program, or in other words, an existing program and an update program can coexist. Also, it is possible to easily switch between the start and stop of the update program. That is, it is possible to select a version from among a plurality of versions of a program and execute the version. Alternatively, a version that corresponds to a downloaded script can be automatically executed. As a result, once installed, it is possible to properly use different versions of a web browser without performing installation/uninstallation, and thus usability is improved.

In Embodiments 1 and 2, web browsers were used as the existing program and the update version program, but the embodiments are applicable to programs other than web browsers. For example, in order to provide a web browser function by an application program, for example, a class called WebView is provided by Java® or the like. With respect to such WebView, the above embodiments are also applicable by using, for example, the version of WebView, the version of a library containing WebView, and the like.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-109317, filed Jun. 1, 2017 which is hereby incorporated by reference herein in its entirety.

What is claimed is:

1. An information processing apparatus comprising:
at least one processor; and
at least one memory in which a computer program executed by the processor is stored,
wherein the processor executes the computer program so as to cause the information processing apparatus to function as:
an update unit that installs an update version program for an existing program as a program that is different from the existing program, and stores registration information that indicates that the update version program has been registered;
an execution control unit that performs control so as to determine which of the existing program and the update version program is to be executed based on the registration information at a time of program execution; and
a removing unit that, in response to an operation for stopping execution of the update version program, stops the update version program, and removes the registration information of the update version program.

2. The information processing apparatus according to claim 1,
wherein after the registration information has been removed by the removing unit, the existing program is executed.

3. The information processing apparatus according to claim 1,
wherein in response to an operation to start execution of the update version program, registration information that indicates that the update version program has been registered is stored by the update unit, and the update version program is executed by the execution control unit.

4. The information processing apparatus according to claim 3, further comprising
a web server for providing screen information to an external apparatus,
wherein an operation for stopping or starting execution of the update version program is performed on a screen that is displayed on the external apparatus based on the screen information provided by the web server.

5. The information processing apparatus according to claim 1,
wherein the existing program and the update version program are web browsers.

6. The information processing apparatus according to claim 1,
wherein the update unit further stores version information that indicates a version of the update version program,
the execution control unit performs control so as to determine which of the existing program and the update version program is to be executed based on the registration information and the version information at the time of program execution, and
in response to the operation for stopping execution of the update version program, the removing unit stops the update version program, and removes the registration information and the version information of the update version program.

7. The information processing apparatus according to claim 6,
wherein the information processing apparatus has correspondence information in which version information that indicates a version of a program downloaded from an external apparatus is associated with version information of the existing program or the update version program that corresponds to the program, and
when the program is downloaded from the external apparatus, the information processing apparatus references to the correspondence information, and executes the existing program or the update version program that corresponds to the downloaded program.

8. The information processing apparatus according to claim 7,
wherein the correspondence information is updated when the update version program is installed.

9. The information processing apparatus according to claim 7,
wherein the existing program or the update version program is a web browser,
the program downloaded from the external apparatus is a script downloaded by the web browser, and
when the script is downloaded, if a version of the web browser does not correspond to the script, a corresponding version of the web browser is activated.

10. A non-transitory computer-readable medium that stores a program for causing a computer to function as:
an update unit that installs an update version program for an existing program as a program that is different from the existing program, and stores registration information that indicates that the update version program has been registered;
an execution control unit that performs control so as to determine which of the existing program and the update version program is to be executed based on the registration information at a time of program execution; and
a removing unit that, in response to an operation for stopping execution of the update version program, stops the update version program, and removes the registration information of the update version program.

11. The non-transitory computer-readable medium according to claim 10,
wherein the update unit further stores version information that indicates a version of the update version program,
the execution control unit performs control so as to determine which of the existing program and the update version program is to be executed based on the registration information and the version information at the time of program execution, and
in response to the operation for stopping execution of the update version program, the removing unit stops the update version program, and removes the registration information and the version information of the update version program.

12. A program management method performed by an information processing apparatus,
the information processing apparatus including an update unit, an execution control unit, and a removing unit,
the method comprising:
by the update unit, installing an update version program for an existing program as a program that is different from the existing program, and storing registration information that indicates that the update version program has been registered;
by the execution control unit, performing control so as to determine which of the existing program and the update version program is to be executed based on the registration information at a time of program execution; and
by the removing unit, in response to an operation for stopping execution of the update version program, stopping the update version program, and removing the registration information of the update version program.
